(19) United States
(12) Patent Application Publication
(10) Pub. No.: US 2007/0025005 A1
(43) Pub. Date: Feb. 1, 2007

(54) Method of protection of information of depopulated magnetic disk apparatus

(75) Inventor: Shoichi Shimizu, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/284,992

(22) Filed: Nov. 22, 2005

(30) Foreign Application Priority Data
Aug. 1, 2005 (JP) 2005-222928

(51) Int. Cl. G11B 27/36

(52) U.S. Cl. 360/31

(57) ABSTRACT

A method of protection of information of a depopulated magnetic disk apparatus having at least one pair of a magnetic head and a magnetic disk including a pair of a magnetic head and a magnetic disk found by tests of the magnetic disk apparatus before shipment to have characteristics of predetermined threshold values or less set to be skipped in reading and writing operations and sold as a magnetic disk apparatus with a one model smaller capacity, comprising detecting a state of deterioration of magnetic heads and magnetic disk surfaces being used, rewriting information recorded at magnetic disk surfaces of pairs judged to have deteriorated on surfaces of skipped magnetic disks corresponding to usable magnetic heads, and prohibiting use of magnetic heads in use, thereby inexpensively and reliably preventing loss of information in the magnetic disk apparatus.

### CROSS REFERENCES TO RELATED APPLICATIONS

The present invention contains subject matter related to Japanese Patent Application No. 2005-222928, filed in the Japan Patent Office on Aug. 1, 2004, the entire contents of which being incorporated herein by reference.

### BACKGROUND OF THE INVENTION

1. Field of the Invention

The present invention relates to a method of protection of information of a depopulated magnetic disk apparatus, more particularly relates to a method of prevention of loss of customer information or other data due to deterioration of a magnetic head or magnetic disk in a depopulated magnetic disk apparatus after shipment.

2. Description of the Related Art

FIG. 1 is a view schematically showing the configuration of a known magnetic disk apparatus. In the figure, reference numeral 11 indicates a 4P (platter) configuration magnetic disk apparatus carrying four magnetic disks (also called “platters”), 111 indicates a depopulated magnetic disk apparatus using a 4P configuration magnetic disk apparatus as a 2P apparatus, 11a indicates a 2P configuration magnetic disk apparatus carrying two magnetic disks, and 11a1 indicates a depopulated magnetic disk apparatus using a 2P configuration magnetic disk apparatus as a 1P apparatus.

Further, like with the magnetic disk apparatuses 11 and 11a, magnetic disk apparatuses where the housings of the magnetic disk apparatuses are the same, but the storage capacities differ according to the requirements of the user are being sold. For example, the capacity of a 4P magnetic disk apparatus is 150 gigabytes, while the capacity of a 2P magnetic disk is 75 gigabytes. While not shown, there are also 36 gigabyte magnetic disk apparatuses with just single magnetic disks.

Inside the magnetic disk apparatuses 11 and 111, reference numeral 12 indicates a spindle for turning the magnetic disk, 13 an actuator for making the magnetic heads move to a read or write position of the magnetic disks, 14 to 17 indicate four platters constituted by magnetic disks, 141 and 142 indicate read or write magnetic heads for the two surfaces of the magnetic disk 14, 151 and 152 indicate read or write magnetic heads for the two surfaces of the magnetic disk 15, 161 and 162 indicate read or write magnetic heads for the two surfaces of the magnetic disk 16, and 171 and 172 indicate read or write magnetic heads for the two surfaces of the magnetic disk 17.

In the magnetic disk apparatuses 11a and 11a1, reference numeral 12a indicates a spindle for turning the magnetic disks, 13a indicates an actuator for making the magnetic heads move to the read or write positions of the magnetic disk, 14a and 15a indicate two platters constituted by magnetic disks, 14a1 and 14a2 indicate read or write magnetic disks for the two surfaces of the magnetic disk 14a, and 15a1 and 15a2 indicate read or write magnetic heads for the two surfaces of the magnetic disk 15a.

In general, magnetic disks and magnetic heads are susceptible to vibration and shock and easily break. Therefore, for example, 4P magnetic disk apparatuses are tested before being shipped out from the factories. If the characteristics of any of the two surfaces of the magnetic disks 14 to 17 or the magnetic heads 141 and 142, 151 and 152, 161 and 162, and 171 and 172 are lower than predetermined threshold values, the magnetic disks or the magnetic disks corresponding to the magnetic heads are deemed defective. Sending out for repair or replacing defective magnetic disks or magnetic disks corresponding to their magnetic heads is too costly, so the magnetic disks or the magnetic disks corresponding to the magnetic heads are set as unusable and the 4P magnetic disk apparatuses are shipped out as 2P magnetic disk apparatuses with one model smaller capacities. These are called “depopulated magnetic disk apparatuses”. For example, if the characteristics of the surface of the magnetic disk 16 or the magnetic heads corresponding to that surface are below predetermined threshold values in a magnetic disk apparatus 11 carrying four magnetic disks as illustrated, the magnetic disk 16 is unusable. Therefore, the magnetic disks 16 and 17 are set as skipped disks and just the remaining two magnetic disks 14 and 15 are set as usable and the apparatus is shipped out as a depopulated magnetic disk apparatus 111. In the depopulated magnetic disk apparatus 111, there may be as many as three usable heads.

Similarly, when the characteristics of one magnetic head or one side of one magnetic head are lower than predetermined threshold values in a 2P magnetic disk apparatus before shipment, the apparatus is shipped out as a 1P depopulated magnetic disk apparatus.

In magnetic disk apparatuses after shipment as well, changes in the amount of flotation of the magnetic heads due to the elapse of time, changes in the MR resistance, changes in the write characteristics, and other changes in characteristics occur. When a magnetic head or magnetic disk becomes completely nonfunctional, the data cannot be read out and the customer is tremendously inconvenienced. To prevent this, conventional magnetic disks have smart functions which collect logs of errors and store the error logs to predict breakdowns. When a breakdown in part of the magnetic disks or magnetic heads in the magnetic disk apparatus is predicted, all of the information in the magnetic disk apparatus is copied to a new magnetic disk apparatus etc. and the magnetic disk apparatus having the magnetic disk or magnetic head predicted as breaking down is replaced so as to prevent information from being lost.

However, even a magnetic disk skipped in a depopulated magnetic disk apparatus sometimes can be used at one side or both sides, so usable heads can be effectively utilized. For example, in the depopulated magnetic disk apparatus 111, the back side of the magnetic disk 16 and the two sides of the magnetic disk 17 among the skipped magnetic disks can be used, and the magnetic disks 162, 171, and 172 among the skipped magnetic heads can be used.

### SUMMARY OF THE INVENTION

An object of the present invention is to prevent in advance the loss of information in a depopulated magnetic disk apparatus and extend the lifetime of magnetic disks by copying information of the surface of a magnetic disk corresponding to a magnetic head predicted to deteriorate or information of the surface of a magnetic disk predicted to deteriorate on to a usable surface of a skipped magnetic disk and thereby without providing a new magnetic disk apparatus and therefore without requiring extra expense.

To achieve this object, according to the present invention, there is provided a method of protection of information of a depopulated magnetic disk apparatus comprised of a plurality of magnetic disks from and to the two surfaces of each of which information is read and written by magnetic heads, having at least one pair of a magnetic head and a magnetic disk including a pair of a magnetic head and a magnetic disk found by tests of the magnetic disk apparatus before shipment to have characteristics of predetermined threshold values or less set to be skipped in reading and writing operations, and sold as a magnetic disk apparatus with a one model smaller capacity, comprising detecting a state of deterioration of magnetic heads and magnetic disk surfaces being used, rewriting information recorded at magnetic disk surfaces of pairs judged to have deteriorated on surfaces of skipped magnetic disks corresponding to usable magnetic heads, and prohibiting use of magnetic heads being use.

According to the present invention, since information is copied onto skipped magnetic disks which are still usable, data will not be lost right after deterioration of a magnetic head or magnetic disk is predicted. Therefore, it is possible to guarantee data in a magnetic disk apparatus economically and safely and possible to extend the lifetime of a magnetic disk apparatus. Further, an improvement in the reliability of a magnetic disk apparatus is led to and the work and expense of maintenance can be reduced.

### BRIEF DESCRIPTION OF THE DRAWINGS

These and other objects and features of the present invention will become clearer from the following description of the preferred embodiments given with reference to the attached drawings, wherein:

FIG. 1 is schematic view of the configuration of a known magnetic disk apparatus;

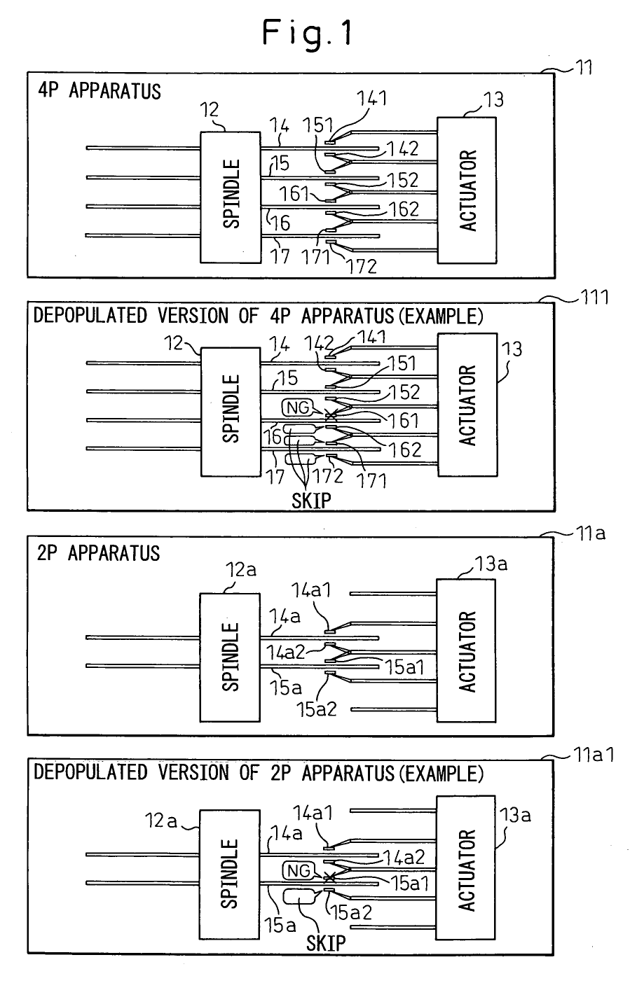

FIG. 2 is a block diagram of the configuration of a magnetic disk drive (magnetic disk apparatus) according to an embodiment of the present invention; and

FIG. 3 is a flow chart for explaining the operation of a microprocessor (MPU) in FIG. 2.

### DESCRIPTION OF THE PREFERRED EMBODIMENTS

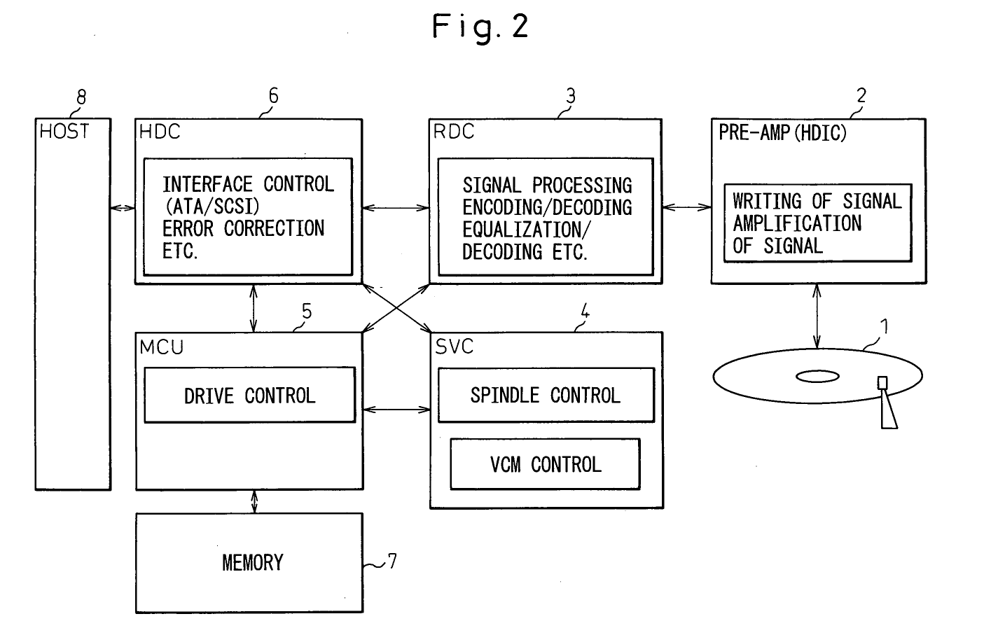

FIG. 2 is a block diagram of the configuration of a magnetic disk drive (magnetic disk apparatus) according to an embodiment of the present invention. In the figure, reference numeral 1 indicates a magnetic disk, 2 a pre-amp (HDIC) which writes a signal to the magnetic disk 1 and amplifies a signal read from the magnetic disk, 3 a read channel (RDC) IC for demodulating the data, 4 a servo controller (SVC) for controlling a rotational spindle of the magnetic disks or controlling a voice coil motor (VCM) for controlling arms of the magnetic heads, 5 a microprocessor (MPU) for controlling write or read operations, providing track information, etc., 6 a hard disk controller (HDC) for controlling the magnetic disk apparatus 1 through the MPU 5 and read channel 3, writing data, starting up a formatter, etc., 7 a memory storing information relating to skipped magnetic disks or magnetic heads, a slice value serving as the reference for judgment of deterioration, the number of usable magnetic heads, and other parameters, and 8 a host computer for transferring a signal with a hard disk controller (HDC) 6 and controlling the magnetic disk apparatus as a whole.

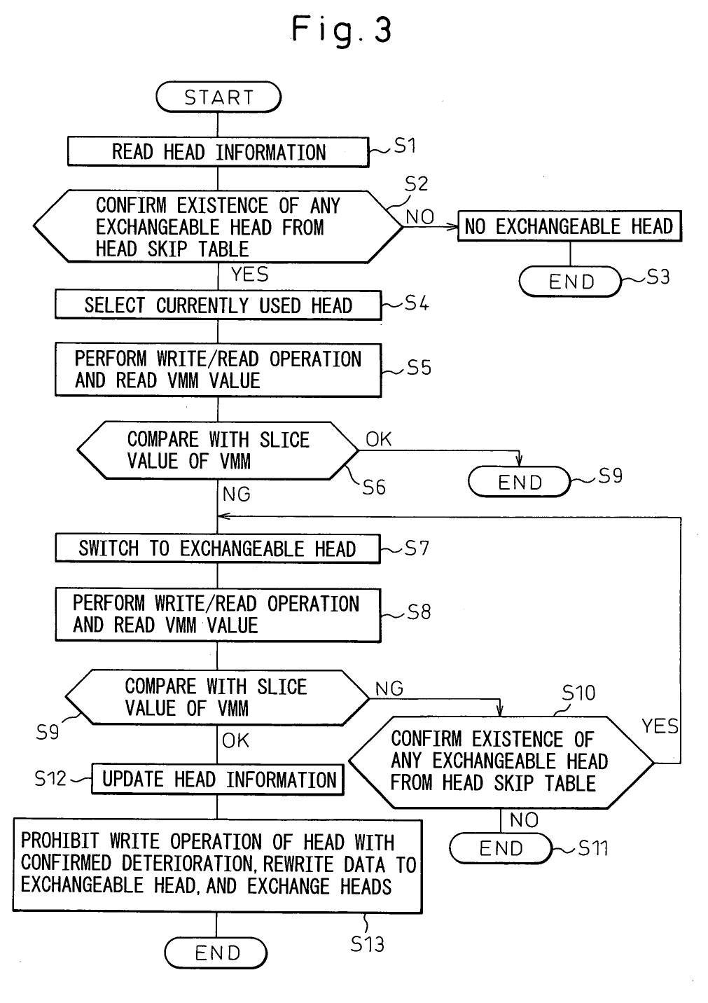

FIG. 3 is a flow chart for explaining the operation of the MPU 5 in FIG. 2. In the figure, at step S1, magnetic head information is read from the memory 7. The magnetic head information includes a head skip table (not shown) recording positions of magnetic heads and exchangeable magnetic disks among the skipped magnetic heads and magnetic disks. Next, at step S2, it is confirmed if the head skip table records exchangeable magnetic heads and magnetic disks. If there are no exchangeable magnetic heads and magnetic disks, the routine ends at step S3.

If there are exchangeable magnetic heads and magnetic disks, the routine proceeds to step S4 where the currently used magnetic head and magnetic disk are selected, a write/read operation is performed by the currently used magnetic head and magnetic disk, and the VMM value is read at step S5.

Next, at step S6, the VMM value read at step S5 is compared with a predetermined slice value. When the read VMM value is lower than the predetermined slice value (NG (“no good”)), it is judged that the magnetic head or magnetic disk is damaged, i.e., damage is predicted, an exchangeable magnetic head and magnetic disk are switched to at step S7, and the magnetic disk is written on/read from and the VMM value is read at step S8. If the VMM value read at step S5 is the predetermined slice value or more, it is judged that the magnetic head and magnetic disk is not predicted as being damaged and the processing ends at step S9.

After reading the VMM value at step S8, the VMM value is again compared with a predetermined slice value at step S9. When the read VMM value is lower than the predetermined slice value (NG), it is judged that the magnetic head or magnetic disk is damaged, i.e., damage is predicted. At step S10, in the same way as at step S2, it is confirmed if the head skip table records any exchangeable magnetic heads and magnetic disks. If there are no exchangeable magnetic heads and magnetic disks, the processing ends at step S11.

If there are exchangeable magnetic heads and magnetic disks, the routine returns to step S7 and steps S7 to S9 are repeated.

If the VMM value read at the judgment of step S9 is the slice value or more (OK), the magnetic head and magnetic disk switched to by updating of the information of the head skip table at step S12 are removed from the skipped list, the magnetic head and magnetic disk detected as deteriorated at step S6 are prohibited from write operations, the data recorded at the magnetic disk prohibited from write operations is rewritten to the magnetic disk corresponding to the magnetic head replaced at step S7 by that magnetic head, then the magnetic head and magnetic disk used are changed from the ones currently used at step S4 to the magnetic head and magnetic disk switched to at step S7.

The state of deterioration is detected at either of the idle times when the power of the magnetic disk apparatus is turned on, when the internal timer of the magnetic disk apparatus is set, and when the magnetic disk apparatus is not operating.

Due to this, when deterioration of a magnetic had or magnetic disk is predicted in for example a 4P depopulated magnetic disk apparatus, data is rewritten using skipped magnetic heads and magnetic disks which are usable to enable that depopulated magnetic disk apparatus to continue to be used.

In FIG. 3, the example was shown of prediction of deterioration of magnetic heads and magnetic disks by measurement of the VMM value, but the present invention is not limited to this. It is also possible to predict deterioration of a magnetic head or magnetic disk by measurement of the VGA value of the AGC, the degree of vertical asymmetry of the output waveform of the magnetic head, and the MR resistance value of the magnetic head or any other means.

As will be clear from the above explanation, according to the present invention, when deterioration of a magnetic head or magnetic disk is predicted in a depopulated magnetic disk apparatus, data is rewritten using skipped magnetic heads and magnetic disks which are usable to enable that depopulated magnetic disk apparatus to continue to be used, so there is no longer a need to newly provide a magnetic disk apparatus and loss of information in a magnetic disk apparatus can be prevented inexpensively and reliably.

While the invention has been described with reference to specific embodiments chosen for purpose of illustration, it should be apparent that numerous modifications could be made thereto by those skilled in the art without departing from the basic concept and scope of the invention.

1. A method of protection of information of a depopulated magnetic disk apparatus comprised of a plurality of magnetic disks from and to the two surfaces of each of which information is read and written by magnetic heads, having at least one pair of a magnetic head and a magnetic disk including a pair of a magnetic head and a magnetic disk found by tests of the magnetic disk apparatus before shipment to have characteristics of predetermined threshold values or less set to be skipped in reading and writing operations, and sold as a magnetic disk apparatus with a one model smaller capacity, comprising
detecting a state of deterioration of magnetic heads and magnetic disk surfaces being used,
rewriting information recorded at magnetic disk surfaces of pairs judged to have deteriorated on surfaces of skipped magnetic disks corresponding to usable magnetic heads, and
prohibiting use of magnetic heads being used.

2. A method of protection of information of a depopulated magnetic disk apparatus as set forth in claim 1, further comprising detecting said state of deterioration by using a read channel function to measure any one of a VMM value, a VGA value of AGC, a degree of vertical asymmetry of an output waveform of a magnetic head, and an MR resistance value of the magnetic head and comparing it with a preset slice value.

3. A method of protection of information of a depopulated magnetic disk apparatus as set forth in claim 1, further comprising detecting said state of deterioration at any one of the idle times when power of the magnetic disk apparatus is turned on, when an internal timer of the magnetic disk apparatus is set, and when the magnetic disk apparatus is not operating.
